(19) United States
(12) Patent Application Publication
(10) Pub. No.: US 2016/0352594 A9
(43) Pub. Date: Dec. 1, 2016

(54) SYSTEM AND METHOD FOR NETWORK ACCESS MONITORING

(71) Applicant: ACCESS LAYERS LTD., Herzelia (IL)

(72) Inventors: Ofer AMITAI, Ramat Hasharon (IL); Nir ARAN, Ra'anana (IL)

(73) Assignee: Access Layers Ltd., Herzelia (IL)

(21) Appl. No.: 13/781,850

(22) Filed: Mar. 1, 2013

Related U.S. Application Data
(60) Provisional application No. 61/605,211, filed on Mar. 1, 2012.

(51) Int. Cl. H04L 12/26

(52) U.S. Cl. CPC H04L 43/065

(57) ABSTRACT

A system and method for collecting characteristics of a current instance of a network connection, where such characteristics include a characteristic of the device used for the connection, the user of the device, and an access layer of the connection. Such collected characteristics are compared to stored characteristics of at least one prior network connection. A signal may be issued with a result of the comparison.

### CROSS REFERENCE TO RELATED APPLICATIONS

The present invention claims benefit of U.S. provisional patent application No. 60/605,211 filed on Mar. 1, 2012, which is incorporated in its entirety herein by reference.

### FIELD OF THE INVENTION

The present invention relates to access of electronic devices to a computer network. More particularly, the present invention relates to monitoring access to a network.

### BACKGROUND OF THE INVENTION

A user may access a computer network (e.g., a system to allow computers to communicate with each other and share information or data) at different times in different manners. For example, a user may, at various times, be using different devices when attempting to access the network. For example, at various times a user may be operating one of several desktop computers, tablet computers, cellular telephones, smart telephones, Internet readers, or Internet telephones. Conversely, several users may be operating a single device at different times. Those users may all be operating the device at various times to access the network.

A single device may be operated to access a network using one or more different network access links or access layers. Such access links for a particular device may include one or more, for example, wired links, wireless links, virtual private networks (VPN), externally hosted or managed (“cloud based”) links, or virtual infrastructure (such as virtual servers). Conversely, a particular access link may serve more than one device or types of devices.

### SUMMARY OF THE INVENTION

Embodiments of the invention may include a method of collecting characteristics of an instance of access to a network by a device, where the collected characteristics include a characteristic of the device, a characteristic of a user of the device in the instance, and a characteristic of a network link for accessing the network by the device in the instance. An embodiment of a method may compare one or more of the collected characteristics of the instance with one or more characteristic from a previous instance of access to the network, and may generate a signal indicating a result of the comparison.

In some embodiments characteristics of an instance may be selected from a group of characteristics including an identifier of an access request, a type of network link used in the connection of the instance, an access point of the network link, a type of device, a manufacturer of the device, a serial number of the device, an operating system running on the device, a username of the user, a time of the instance of access, and a location of the instance of access. Other characteristics may also be collected and used in a comparison.

In some embodiments a device may be selected from or include a group of devices such as a laptop computer, a tablet computer, a desktop computer, a telephone, and a virtual desktop.

In some embodiments a network link may selected from a group of network links consisting of a virtual personal network, a wireless network, a wired network, a local area network, a virtual network, and a software as a service network link.

In some embodiments collecting a characteristic may include acquiring login information from the user.

In some embodiments comparing a characteristic may include retrieving stored characteristics of a previous instance by identifying among the stored characteristics of such previous instance, a characteristic that is identical to a characteristic of a current instance.

In some embodiments comparing characteristics of an instance with a characteristic from a prior instance may include determining whether the characteristic is within a tolerance range of the characteristics of one or more characteristics of a previous instance. In some embodiments the generated signal indicates whether the characteristic from an instance is expected, such as whether an advance warning or indication of a characteristic has been stored in a memory.

In some embodiments a signal may be generated or issued that may control, terminate or allow access to the network. In some embodiments, an alert may be issued based on the generated signal.

Embodiments of the invention may include a method for collecting characteristics of an instance of a network connection, where the characteristics include a device of the subject instance, a characteristic of a user of the device in the subject instance, and a characteristic of a link layer of the subject instance. Embodiments of the method may further locate a first characteristic of a prior instance of a network connection that is identical with a first characteristic of one or more of the characteristics of the subject instance. A method may comparing a second characteristic of the prior instance of a network connection with a second characteristic of the subject instance; and generate a signal indicative of a result of the comparison.

In some embodiments locating a first characteristic of a prior instance may include searching a database of previous instances of network connections. In some embodiments a method may include controlling access to the network by the device.

Embodiments of the invention may include a system having a memory to store characteristics of instances of prior network connections; and characteristics of a current instance of a network connection, and a processor to match a first characteristic of a current instance with a first characteristic of one or more prior instances, and to compare a second characteristic of the current instance with a second characteristic of one or more of the prior instances; and to generate a signal indicating a result of the comparison.

In some embodiments, stored characteristics may include a characteristic of a device used in an instance, a characteristic of a user of the device in an instance, and a characteristic of a network link in an instance.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically illustrates a system for application of network access monitoring in accordance with an embodiment of the present invention.

FIG. 2 schematically illustrates a network server of the system shown in FIG. 1 in accordance with an embodiment of the present invention.

FIG. 3 schematically illustrates profiles of connectivity events for network access monitoring in accordance with an embodiment of the present invention.

FIG. 4 is a flowchart depicting a method for network access monitoring in accordance with an embodiment of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a non-transitory computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a profile of a current connectivity event or instance or event of access by a device to a network (a computer network) may be obtained or collected. For example, the profile may be obtained by a server or other device that controls access to the network, or that cooperates with a device that controls access to the network. The profile represents a collection or record of data elements that includes identifying information regarding the device, a user of the device (“user” as used herein may represent a person, a service, or a group or class of people), and a network link or access layer being utilized by the device to connect to the network. Other characteristics of the connectivity event, device, the user, or the network link may be included in the profile.

Access monitoring in accordance with an embodiment of the present invention may include, monitoring, regulating, managing, or reporting on the obtained profile or on anomalies that may arise in connection with the contents of the profile.

A single connectivity event or instance of network access involves a single combination of a single user or service requesting access on a particular device, where such access is to be gained over a particular network link or layer. However, a single user may, at different times, request network access using different devices and different network links. Similarly, a single network link may at various times be utilized to enable access by different users operating different devices. A single device may at various times be used by different users, and may utilize different network links to access the network.

For example, a user may at various times access a network over a personal computer, over a tablet computer, or over a smartphone. A personal computer may at various times be used by a first user or by a second user. A tablet computer may access a network at various times over a wireless link or through a virtual private network (VPN). Similarly, a user may typically gain access at a particular time of day over a laptop by way of a wireless link from a given geographical region such as one near the user's home.

For example, identifying information of the device may be obtained by communicating with appropriate hardware, firmware, or software of the device. Identifying information for the device may include, among other information, an Internet Protocol (IP) address, a type of device (e.g., laptop computer, tablet computer, desktop computer, virtual desktop, smartphone, or mobile telephone), a manufacturer or model of the device, a serial number or other identifying number of the device, and a type or version of an operating system that is running on the device. A device that may be establishing or requesting access to the network may include a desktop computer, a tablet computer, a mobile or stationary telephone, an Internet reader, an Internet telephone, or any other device that may be operated to gain access to a network.

Identifying (ID) information for the user may be obtained, e.g., from identifying information provided by the user when logging in to the device, or by other methods. Identifying information may be stored on a device owned by or commonly used by a certain user, or stored by a certain software process commonly used by a certain user. A user may include an individual user (e.g., person), or a service such as a network browser that may request access to the network. Such identifying information may include, for example, among other types of identifying information, a name or username of the user, a userID, a password type (option), voice or biometric data, or identifying data that is encoded (e.g., in a barcode, two dimensional barcode, magnetic strip or disk, radiofrequency tag, or other manner) in a device (e.g., a key, card, badge, or other access device) that is read or sensed when accessing the device or the network.

Identifying information regarding the network (e.g., type of link, access point or resource used in establishing the link) may be obtained when communication is established between the network link and the network. For example, a network link over which access or connectivity to a network may be requested or granted may include a wired link, a wireless link, a VPN, a cloud based link (e.g., externally hosted or managed link), virtual infrastructure (such as a virtual server), or another type of link or path of connectivity.

As used herein, a connectivity event includes an instance of a user operating a device that uses a network link to attempt to access to a network, whether or not the connection is successful or access is actually enabled. A user may access a network to gain access to remotely stored data, to remotely operated programs or for other reasons.

The obtained current profile of the connectivity event may be stored in a database or in another manner to enable access in connection with a future or subsequent connectivity event. For example, the profile may be stored on a data storage device in the form of a data structure, or as a record in a stored database.

The obtained or collected current profile may be compared with one or more relevant previous profiles that were obtained during previous connectivity events. For example, one or more relevant previously stored profiles may share a common identification of least the same device, user, or network link as the current profile, or of two of the above. Data in current profile and in the relevant previous profile may be compared.

Profiles may be compared to identify groups of connectivity events having similar characteristics. For example, a database may identify a list of devices that use a particular network link to access the network, a list of users who typically operate particular devices to access the network, or a list of devices that a utilizes a particular network link to access the network.

A comparison may indicate the current profile as being similar or dissimilar from previous profiles. The comparison may be evaluated against predetermined criteria. The criteria may define tolerance levels for various characteristics that are included in the profile. Tolerance level criteria may vary in accordance with various conditions or characteristics of the current connectivity event. For example, a tolerance level may determine whether a location of the device indicated by the current profile is within an expected geographic region based on locations during previous connectivity events. The size of the geographic region may be dependent on the type of device (e.g., mobile or stationary) or connection (e.g., wired or wireless).

A signal or notification may be generated in response to one or more results of the comparison. For example, the signal or notification may indicate whether one or more characteristics of the current connectivity event fall within an expected range of characteristics based on previous connectivity events or other events or criteria. The signal may be for example an electronic signal, a digital code, or other information, and be utilized by a processor that is configured to perform network access processing, or another processor that is configured to receive or process the generated signal. For example, the signal may be utilized in determining whether or not to enable the device to access the network, in triggering or generating a request for additional authentication, or in issuing a notification to an administrator of the network or in shutting down or limited an access of a user or a device. A signal may include for example a warning to a network operator to a network security system indicating that a suspicious user or access is being attempted. A signal may issue an alert to the operator, may limit, deny or close access to the user or take some other step to isolate, query, identify or otherwise resolve a suspicion about a user or a request to gain access.

For example, as a result of a generated signal that indicates the profile of the current connectivity event is compatible with profiles of previous connectivity events, access to the network may be enabled. Such compatibility may include for example a change in a usual circumstance of access that is within tolerable limits. For example, if past access records indicate that the user logs on to the network on weekdays from his office, a log on attempt on a weekend from his office may be within a tolerable limit or deviation. A log on attempt from the office at 4 AM may, for example be outside a tolerance level and may be incompatible with the set tolerances. On the other hand, a generated signal may indicate that the profile of the current connectivity event is not compatible, or is only partially compatible, with profiles of previous connectivity events. Such incompatibility may be indicative of unusual circumstances (e.g., the user is away from the users usual device or location), or of a suspected illegitimate or undesired attempt to access the network. As a result of such a signal, access to the network may be denied, additional authentication information may be requested, or both.

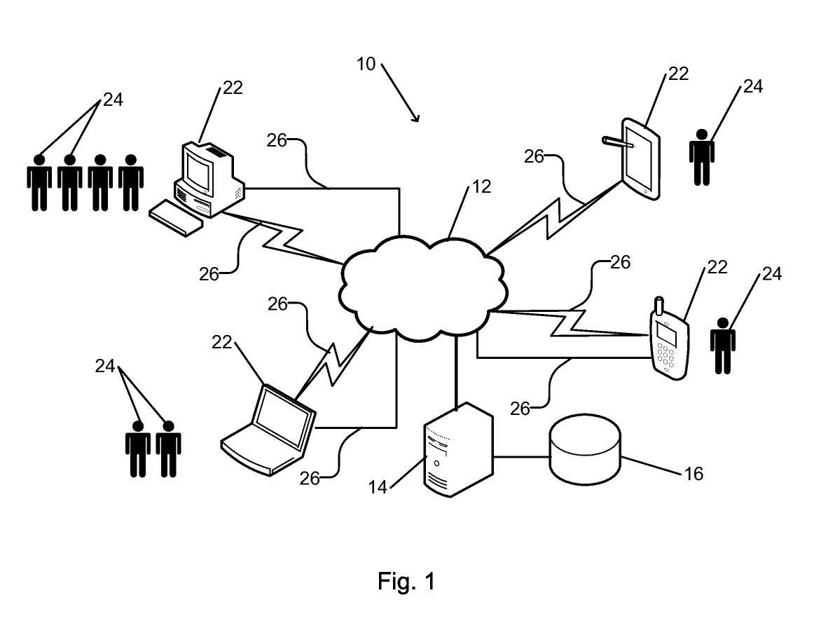

FIG. 1 schematically illustrates a system for application of network access monitoring in accordance with an embodiment of the present invention.

Network access monitoring system 10 may monitor access to network 12. For example, network 12 may include any network that enables intercommunication among different devices 22, or between a device 22 and a network server 14.

A device 22 may include, for example, a stationary computer (e.g., a desktop or other stationary computer), a portable computer (e.g., laptop, tablet, or handheld), a cellular telephone, a smartphone, an Internet reader, an Internet telephone, or any other device that may be connected to network 12. Each device 22 includes one or more components that enable identification of that device 22. For example, a component of device 22 may include encoded identification information. The identification information may be read or interpreted by an appropriately configured processor or device that communicates with device 22. Device 22 may include one or more processors, memory units, communication units, and input/output components.

A device 22 may be configured to provide additional information related to a connectivity event. For example, a device 22 may include a clock or clock circuit that provides a signal that is interpretable to yield a time (e.g., date and time of day, or other time-related quantity) of an event, such as a connectivity event. A device 22 may be provided with a navigation device, or with processing capability or circuitry, that enable determination of a location of device 22, e.g., by analysis of received signals (e.g., from a satellite system such as the Global Positioning System (GPS) or from a cellular communications system).

Each device 22 may be operated by one or more users 24. For example, a device 22 may include a plurality of connected terminals or interfaces that enable concurrent access to network 12 by two or more users 24. As another example, a device 22 may be operated sequentially by two or more different users 24 using a single terminal or interface. Each user 24 that operates a device 22 may be required to provide identifying information, e.g., as part of a login procedure. The identifying information may be designed to uniquely identify each user 24 of device 22.

Each device 22 may be configured to communicate with network 12 via one or more network links 26. For example, a device 22 may be configured with one or more ports or communications devices (e.g., antennas) to enable connection to network 12, via a wired or wireless network link 26. A network link 26 may include, for example, a wired link, a wireless link, a VPN, an externally hosted or managed (“cloud based”) link, a virtual infrastructure (such as a virtual server), or any other access link or access layer that enables a device 22 to communicate with network 12. A device 22 may be configured to automatically select a network link 26 from one or more options, or may be operable by a user 24 to select a network link 26. Signals generated during connection to network link 26 or to network 12 may be interpretable to yield a time and location of a connectivity event in which a device 22 attempts or requests access to network 12.

Network server 14 is configured to communicate with one or more devices 22 via network 12. Network server 14 includes one or more intercommunicating servers, computers, or other computing devices, all of which are collectively represented by network server 14. Network server 14 transfer may communicate with one or more databases, all of which being collectively represented by database 16. For example, database 16 may include one or more profiles that characterize corresponding connectivity events. Data on database 16 may be organized into records or fields. Database 16 may be suitably indexed to enable querying or retrieval of data from database 16.

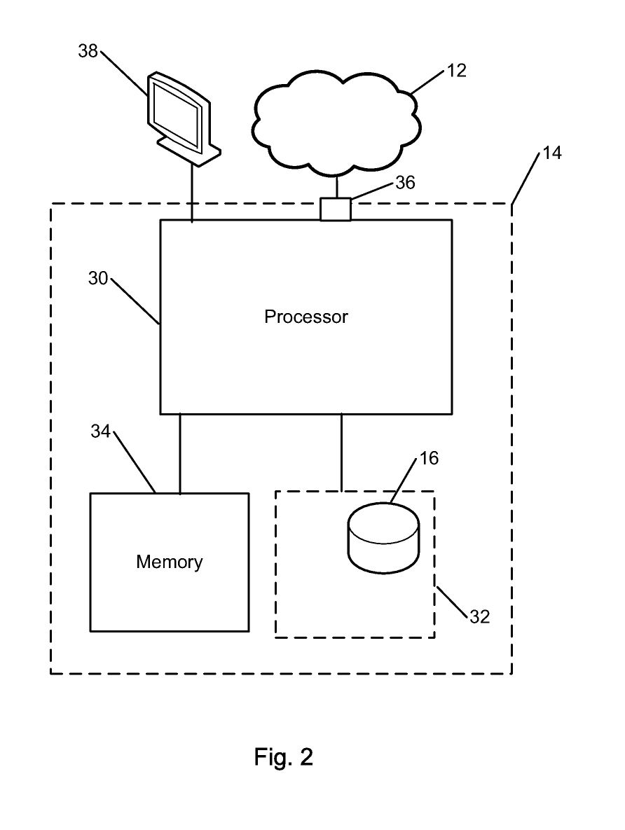

FIG. 2 schematically illustrates a network server and configuration of the system shown in FIG. 1, in accordance with an embodiment of the invention.

Network server 14 includes a processor 30. Processor 30 may include one or more separate or intercommunicating processing devices. Processor 30 may operate in accordance with programmed instructions. For example, processor 30 may operate in accordance with programmed instructions to execute or perform network access monitoring in accordance with an embodiment of the present invention, to obtain or collect a profile that characterizes a connectivity event to network 12, or to generate a signal that indicates a result of network access monitoring. Furthermore, processor 30 may be configured to operate in accordance with programmed instructions to control access to network 12.

Processor 30 of network server 14 may communicate with data storage unit 32. Data storage unit 32 may be incorporated into network server 14, or may be provided with a suitable communications link to enable access by network server 14. For example, data storage unit 32 may include one or more fixed or removable, non-volatile data storage devices or computer-readable media. Data storage unit 32 may be utilized to store programmed instructions for operation of processor 30, data or parameters for use in operation of processor 30, or a result of operation of processor 30. Data storage unit 32 may be used to store one or more profiles, e.g., in the form of data structures or database records. Data storage unit 32 may be utilized to store database 16, or one or more components of database 16, such as one or more profiles.

Processor 30 of network server 14 may communicate with memory unit 34. Memory unit 34 may be incorporated into network server 14 or processor 30. Memory unit 34 may include one or more volatile or non-volatile memory devices. Memory unit 34 may be utilized to store programmed instructions for operation of processor 30, data or parameters for use in operation of processor 30, or a result of operation of processor 30. For example, memory unit 34 may be utilized to store a plurality of characteristics of each of a plurality of instances of prior network connections and a plurality of characteristics of a current instance of a network connection. For example, the characteristics may be stored in the form of profiles of each of the prior and current instances.

Processor 30 of network server 14 may communicate with network 12 via network connection 36. For example, network connection 36 may represent one or more wired or wireless connections.

An operator of network server 14 (e.g., a network supervisor) may communicate with network server 14 via input/output 38. For example, network server 14 may generate or issue an alert or notification that may be displayed on a display screen, or via another output device, of input/output 38. An operator may input a response, command, parameter, or instruction to network server 14 via an input device (e.g., keyboard, keypad, pointing device, or touch screen) of input/output 38.

For example, processor 30 may operate to match a stored first characteristic of a current instance with a stored first characteristic of a first instance of a stored plurality of instances of prior network connections. Processor 30 may further operate to compare a stored second characteristic the current instance with a stored second characteristic of the first instance of the plurality of instances of prior network connections. Processor 30 may further operate to generate a signal that indicates a result of the comparison. A plurality of characteristics of the current or prior instance of a network connection includes a characteristic of a device used in that instance (e.g., of a device 22 as in FIG. 1), a characteristic of a user of the device in that instance (e.g., of a user 24), and a characteristic of a network link in that instance (e.g., of a network link 26). For example, a first characteristic of an instance of network access may include an identity of the device used in such access. Processor 30 may find prior access instances of access of such same device, thereby matching at least one characteristic of a current instance of such device with prior access instances of such same device. Processor 30 may compare other characteristics of the current instance with such other characteristics of the prior instance of such the device. For example, if stored records of access instances indicate that a laptop with serial number 12345678 is usually used by employee John Smith in Texas, processor may identify a match of serial number 123454678 in a current instance as being identified with the same laptop used in prior access instances, and may compare other characteristics of the current access instance by the laptop with such other characteristics of prior access instances by the laptop. If in the current instance laptop 12345678 is being used for access by employee Lee Wong in Shanghai, then a signal may be issued indicating that the other characteristics of a current access instance of such laptop are not within compatible limits In accordance with an embodiment of the present invention, network access monitoring includes collecting or obtaining a profile of a connectivity event. The connectivity event may include a request to enable a device to access the network, or an instance of gaining of access to the network by a device. The profile includes at least an identity of the device, of a user that is calling for the access or that is operating the device to gain access to the network, and of a network link or access layer over which the access is being facilitated.

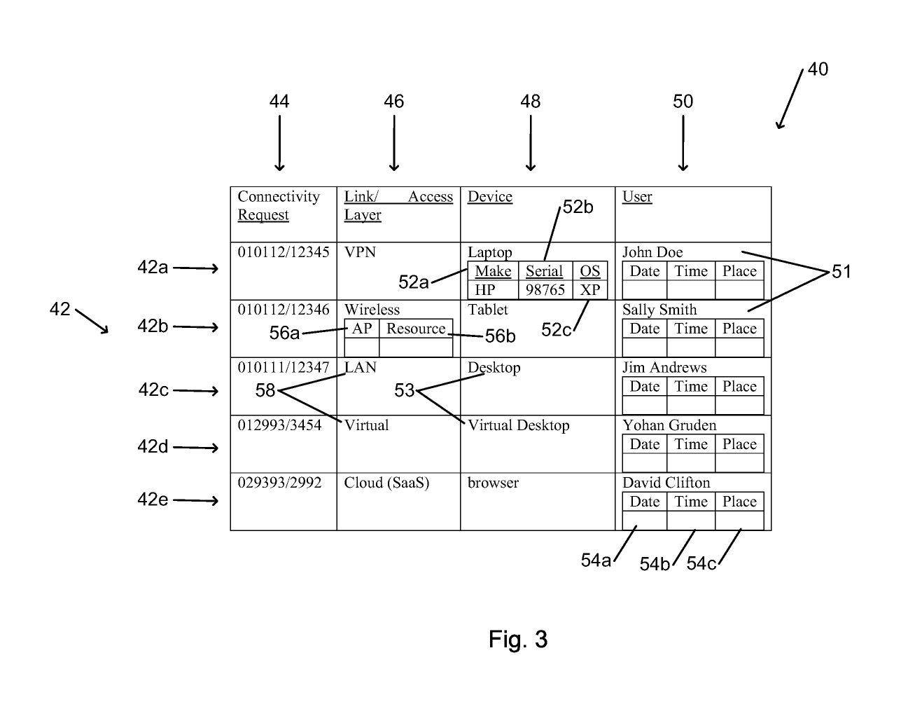

FIG. 3 schematically illustrates profiles of connectivity events for network access monitoring in accordance with an embodiment of the present invention.

A set of profiles 42 of connectivity events may be stored for example in database 40. For example, database 40 may represent an indexed database, or a physical or logical region of a data storage device that is used to store profiles 42 (e.g., in the form of files or data structures).

For clarity and convenience, the number or profiles 42 shown in FIG. 3 is limited. A database 40 may include many more profiles 42 than the illustrated number of profiles. For example, database 40 may be associated with a particular network, a type of network, a network service, or a collection networks.

Each profile 42 (individually labeled as profiles 42a through 42e) represents a connectivity event. Each connectivity event includes an instance of access to a network, in particular, a request for connectivity to the network. For example, each profile 42 may be stored in the form of a record of database 40, or in the form of a data file or data structure.

Database 40 as illustrated in FIG. 3 should be understood as representing a single schematically illustrated example. Although each profile 42 is shown as including a particular set of data fields and in a particular data format, other sets of data fields and formats are possible.

Each profile 42 is distinguished from other profiles 42 by a connectivity request identifier 44. Connectivity request identifiers 44 may represent a component of a profile 42, for a series of sequentially initiated connectivity requests may be assigned sequential identifying numbers, may be identified by an address designating a location where profile 42 is stored in a memory unit or data storage device, may be identified by encoding one or more characteristics of the connectivity event (e.g., time or location), may be assigned identifiers in any other manner, or may not be assigned connectivity request identifiers 44.

Each profile 42 includes a device characteristic 48. For example, device characteristic 48 may include one or more data fields of a record of database 40. Device characteristic 48 specifies one or more characteristics of a device for which network access is being requested in the corresponding connectivity event. Device characteristic 48 includes at least an identifier (ID) of the device. The device ID may include, for example, an explicit or implicit (e.g., derivable from other characteristics) indication of a type of the corresponding device (represented by device type field 53). In the example shown, the device characterized by device characteristic 48 is identified in device type field 53 as a laptop computer in profile 42a, a tablet computer in profile 42b, a desktop computer in profile 42c, a virtual desktop in profile 42d, and a browser in profile 42e. Device characteristic 48 may include additional characteristics of a characterized device. A particular additional characteristic may be applicable or appropriate to one or some types of devices, but not to others. For example, additional characteristics may include (e.g., for a device in the form of a computer), a manufacturer or producer of the device (represented by device make field 52a), a model number of the device, a serial number of the device (represented by device serial field 52b), a type or version of an operating system (OS) running on the device (represented by device OS field 52c), a version of an application, program, browser or other software that is installed on the device, and any other characteristic that may characterize a device for which network access is requested.

Each profile 42 includes a user characteristic 50. For example, user characteristic 50 may include one or more data fields of a record of database 40. User characteristic 50 specifies one or more characteristics of a user that is requesting network access in the corresponding connectivity event. User characteristic 50 includes at least an identifier of the user. For example, user characteristic 50 may include a name username of the user (represented by username field 51), a resource accessed by the user, a time of access by the user (e.g., specified as date and time of day, represented by user date field 54a and user time field 54b), an access code associated with the user, a name of a service (e.g., when the user is in the form of a service), a location of the user (represented by user place field 54c, e.g., derivable from network link characteristics or device characteristics and associated with the user), or any other characteristic that characterizes a user operating a device to access a network.

Each profile 42 includes a network link characteristic 46. For example, network link characteristic 46 may include one or more data fields of a record of database 40. Network link characteristic 46 specifies one or more characteristics of a network link via which a network access by a device is being requested in the corresponding connectivity event. Network link characteristic 46 includes at least an identifier of the network link. The network link identifier may include, for example, an explicit or implicit (e.g., derivable from other characteristics) indication of a type of the corresponding network link (represented by network link type field 58). In the example shown, the network link characterized by network link characteristic 46 is identified in network link type field 58 as a VPN in profile 42a, as a wireless network link in profile 42b, as a local area network (LAN) in profile 42c, as a virtual network link in profile 42d, and as a software as a service (SaaS) network link in profile 42e.

Network link characteristic 46 may include additional characteristics of a characterized network link. A particular additional characteristic may be applicable or appropriate to one or some types of network links, but not to others. Additional characteristics may include a physical location of the network link (e.g., for a network link that includes a wired connection, or a wireless connection that connects at a particular location. For example, a physical location may be given by an access point (AP) to a wireless network (represented by network link AP field 56a) or by a cell of a cellular telephone network. Additional characteristics may include a resource that is utilized in forming the network link (represented by resource field 56b) or any other characteristic that may characterize a network link via which network access is requested.

A profile 42 may include additional information related to the corresponding connectivity event, or to the device, user, or network link. For example, a profile 42 may include information regarding a length of time that was required to authenticate a device or a user, a duration of a connection to the network, a quantity of data (e.g., number of packets) sent via the network connection, or resources that were accessed via the network connection. Further information may include a startup time or shutdown time for the device. Other examples include a location of the user, a location of the device, a time of an access request, a resource accessed by the user, or a resource accessed by the device.

A method for network access monitoring that includes comparing a profile of a current connectivity event with previously obtained profiles of previous connectivity events may be executed.

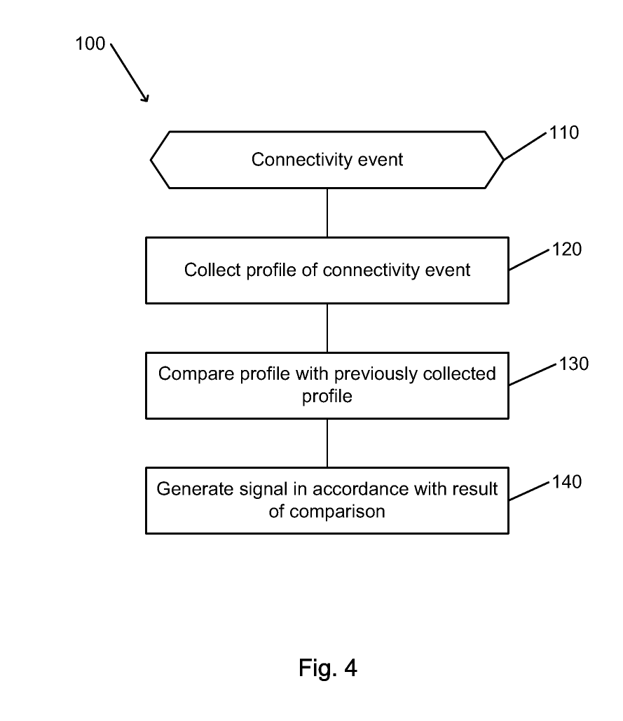

FIG. 4 is a flowchart depicting a method for network access monitoring in accordance with an embodiment of the present invention.

It should be understood with respect to the flowchart, that the division of the depicted method into separate operations represented by blocks of the flowchart has been selected for convenience only. Alternative division of the depicted method into discrete operations may be possible and yield equivalent results. Any such alternative division of the depicted method into discrete operations should be understood as representing an embodiment of the present invention.

Furthermore, it should be understood that unless indicated otherwise, that the order of operations of the depicted method as represented by the positions of the blocks in the flowchart has been selected for convenience only. Execution of the depicted operations in an alternative order, or concurrent execution of operations of the depicted method, may be possible and yield equivalent results. Any such reordering of operations of the depicted method should be understood as representing an embodiment of the present invention.

Network access monitoring method 100 may be implemented, for example, by a server of a network or by a processor, computer, or any other device or service that is configured to monitor or control access to a network. The network may include any network that enables a device to communicate with other devices, with a server or service, such as, for example, a wired or wireless network, an intranet, the Internet, a telephone network, or other network.

Execution of network access monitoring method 100 may be initiated by a current connectivity event (block 110). For example, a connectivity event includes an instance of access to the network by a device that includes request for access by the device to the network. Thus, receiving or detection of the request for access may initiate execution of network access monitoring method 100. For example, a connectivity event may be initiated by turning on or activating the device, by physically connecting the device to an access point to the network (e.g., connecting an appropriate cable between the device an a network connection point, by moving the device to a point where a wireless connection to the network is enabled), or by operating the device to access the network (e.g., attempt to connect to an Internet site, send or receive an email, or access a network-provided service). For example, the connectivity event may be detected by detecting a network switch that is being used to access the network, or a network to which access is being requested.

A current profile of the current connectivity event may be collected (block 120). The current profile includes at least an indication of an identity of the device with regard to which access to the network is being requested, an identity of a current user of the device, and an identity of a network link via which access by the device to the network is being requested. For example, the device may be probed or queried to determine its IP address or to determine the type of operating system, software, virus control or other criteria that are present on the device. An identity of the user that is logged onto that device may be requested.

The current profile may include additional data that characterizes the connectivity event, the device, the user, or the network link. For example, data for the current profile may be collected by communicating with data that is stored in a memory or data storage device of the device, by communicating with the user (e.g., as part of a logon procedure), or by detecting a network link (e.g., by detecting communication via a particular path, port, or network switch).

The current profile may be saved or stored for future reference or retrieval, e.g., in a database of profiles. For example, the current profile may be saved as a record in a database, or may be saved as a data file or data structure.

The current profile of the current connectivity event is compared with one or more previously collected profiles of one or more previous connectivity events (block 130). For example, the previously collected profiles may be stored in a database. Relevant previously collected profiles may be retrieved from the database. For example, the database may be queried, or appropriately indexed, to enable retrieval of previously collected profiles that share one or more common characteristics with the profile of the current connectivity event. For example, previously collected profiles may be retrieved that identify the same device, user, or network link as the current profile. Stricter criteria for retrieving a previously collected profile may be applied. For example, two or more common identities with the current profile may be required, or one or more additional common characteristics may be required.

Once one or more relevant previously collected profiles are retrieved, additional corresponding characteristics defined in the current profile and in the retrieved previously collected profile may be compared. Alternatively or in addition, characteristics of the current profile may be compared to a composite or representative profile that is based (e.g., by averaging or statistical analysis) on combining characteristics obtained from a set of two or more (a plurality of) previously collected profiles.

For example, a previously collected profile may be located on the basis of a first characteristic. For example, a first characteristic of a prior instance of a network connection may be found or located that is identical with a first characteristic of the current profile of the current instance of a network connection. A second characteristic of the prior instance may then be compared with a second characteristic of the current instance.

For example, the current profile and a previously collected profile may be considered to be similar, if some or all of the characteristics defined in the current and previously collected profiles are identical or similar within predefined tolerance ranges. Characteristics or sets of characteristics that are defined in the profiles may be separately compared. A set of characteristics to be compared, or a number of similar or common characteristics that enable the two profiles to be considered similar may be defined by predetermined criteria.

Tolerance ranges or thresholds may be established for characteristics that are defined in a profile. Tolerance ranges may be defined as specific to particular characteristics or sets of characteristics.

For example, based on previous connectivity events, or based on knowledge of typical use patterns, a particular user may be characterized as being expected to access the network using a tablet computer over a wireless link or a over a wired link from an office location. However, the same user accessing the network using tablet computer over a VPN connection from another office location may be considered aberrant. As another example, a user may be expected to use a smartphone over a wireless link. However, the user using that smartphone over a wired network or VPN might be considered aberrant.

A tolerance range may be defined for one or more profile characteristics, and the ranges varied (e.g., expanded or contracted) in light of other profile characteristics. For example, an access to the network via a VPN may be considered as aberrant when requested from a location (e.g., country) from which previously collected profiles show no previous access by that user. Similarly, a request for access by a desktop computer over a wireless network or VPN may be indicated as an aberrant. In another example, records of prior instances of a network connection for a particular user may indicate that the user logs on to a network during working hours over a wired LAN from a desktop in his office, and after working hours over a VPN from a laptop at his home. A processor may compare a characteristic of a current connection instance showing that another user has connected over a VPN from the laptop at such same home, and may generate a signal indicating aberrance in such comparison. In contrast, a current instance may indicate that the user is using his laptop at home over the VPN during working hours. In some embodiments a comparison of the characteristics of the current instance to prior instance may detect the difference in the characteristic of the time in which the current instance is made relative to the time of prior instances, but such difference may be within a pre-defined tolerance level of differences in characteristics, and may not issue a signal showing an aberrant difference or some other alarm.

A range of acceptable usages of a user over time may be learned on the basis of continually collected profiles.

The comparison may also include monitoring concurrent access by the identified device or user. For example, a profile of a concurrent connectivity event or instance of access by whose characteristics identify that same device or user as identified in the current profile may be detected. Thus, the user or device that is defined in the current profile may be detected to be concurrently accessing or requesting access to the network, e.g., from another location. In such a case, the comparison may indicate that the characteristics of the current profile are unexpected.

A signal may be generated in accordance with a result of the comparison between the current profile and previously collected profiles (block 140). For example, the signal may indicate a degree of similarity between the current profile and one or more previously collected profiles (or a composite or representative profile based on one or more previously collected profiles). For example, the signal may indicate whether or not the characteristics of the current profile fall within an expected range of characteristics. As another example, the signal may indicated a degree of expectedness of the current profile (e.g., as a fraction or percentage, or as a value on a scale of values). As another example, the may include separate signals that each indicate a degree of expectedness of a characteristic of the profile, or of a set of characteristics.

The generated signal may control or manage access to the network, or be utilized in managing or supervising access to the network. For example, in response to a signal that indicates the characteristics of the current profile are expected (as compared with previously collected profiles), access by the combination of device, user, and network link may be allowed or enabled. The generated signal may include an issued alert or report, or an alert or report may be issued in response to a generated signal that indicates unexpected characteristics of the current profile, e.g., as a notification to a network administrator, or access to the network may be denied.

It will be appreciated by persons skilled in the art that embodiments of the invention are not limited by what has been particularly shown and described hereinabove. Rather the scope of at least one embodiment of the invention is defined by the claims below.

1. A method comprising:
collecting a plurality of characteristics of an instance of access to a network by a device, said characteristics of an instance including a characteristic of the device, a characteristic of a user of the device in said instance, and a characteristic of a network link for accessing the network by the device in said instance;
comparing a characteristic from said plurality of characteristics of an instance with a characteristic from a plurality of characteristics of a previous instance of access to the network; and
generating a signal indicating a result of the comparison.

2. The method of claim 1, wherein the characteristics of said instance further include a characteristic selected from the group of characteristics consisting of an identifier of an access request, a type of said network link, an access point of the network link, a type of the device, a manufacturer of the device, a serial number of the device, an operating system running on the device, a username of the user, a time of the instance of access, and a location of the instance of access.

3. The method of claim 1, wherein the device is selected from the group of devices consisting of a laptop computer, a tablet computer, a desktop computer, a telephone, and a virtual desktop.

4. The method of claim 1, wherein the network link is selected from the group of network links consisting of a virtual personal network, a wireless network, a wired network, a local area network, a virtual network, and a software as a service network link.

5. The method of claim 1, wherein said collecting a plurality of characteristics comprises acquiring login information from the user.

6. The method of claim 1, wherein said comparing a characteristic comprises retrieving a stored plurality of characteristics of said previous instance by identifying among said stored plurality of characteristics of said previous instance, a characteristic that is identical to a characteristic of said instance.

7. The method of claim 1, wherein said comparing a characteristic from said plurality of characteristics of an instance with a characteristic from a plurality of characteristics of a previous instance comprises determining whether said characteristic from said plurality of characteristics of an instance is within a tolerance range of said characteristic from a plurality of characteristics of a previous instance.

8. The method of claim 1, wherein the generated signal indicates whether said characteristic from a plurality of characteristics of an instance is expected.

9. The method of claim 1, further comprising controlling access to said network based on said generated signal.

10. The method of claim 1, further comprising issuing an alert based on the generated signal.

11. A method comprising:
collecting a plurality of characteristics of an instance of a network connection, said plurality of characteristics comprising a characteristic of a device of said instance, a characteristic of a user of said device in said instance, and a characteristic of a link layer of said instance;
locating a first characteristic of a prior instance of a network connection that is identical with a first characteristic of said plurality of characteristics of said instance;
comparing a second characteristic of said prior instance of a network connection with a second characteristic of said plurality of characteristics of an instance; and
generating a signal indicative of a result of the comparison.

12. The method of claim 11, wherein said locating a first characteristic of a prior instance comprises searching a database of previous instances of network connections.

13. The method of claim 11, wherein said generating a signal comprises controlling access to the network by the device.

14. A system comprising:
a memory to store:
a plurality of characteristics of each of a plurality of instances of prior network connections; and
a plurality of characteristics of a current instance of a network connection; and
a processor to:
match a first characteristic of said plurality of characteristics of a current instance with a first characteristic of a first instance of said plurality of instances of prior network connections;
compare a second characteristic of said plurality of characteristics of a current instance with a second characteristic of said first instance of said plurality of instances of prior network connections; and
generate a signal, said signal indicating a result of the comparison.

15. The system of claim 14, wherein the plurality of characteristics of an instance of said plurality of instances of prior network connections comprises a characteristic of a device used in that instance, a characteristic of a user of said device in that instance, and a characteristic of a network link in that instance.

16. The system of claim 15, wherein the device is selected from the group of devices consisting of a laptop computer, a tablet computer, a desktop computer, a telephone, and a virtual desktop.

17. The system of claim 15, wherein the network link is selected from the group of network links consisting of a virtual personal network, a wireless network, a wired network, a local area network, a virtual network, and a software as a service network link.

18. The system of claim 15, comprising a processor to control access to the network.

19. The system of claim 15, comprising a processor to issue an alert.
